(19) United States
(12) Patent Application Publication
(10) Pub. No.: US 2017/0302503 A1
(43) Pub. Date: Oct. 19, 2017

(54) IMAGE-TYPE NOTIFICATION AND RECORDING METHOD AND SYSTEM OF HARDWARE EVENT AND STATUS OF ELECTRONIC DEVICE, RECORDING MEDIUM, AND COMPUTER PROGRAM PRODUCT

(71) Applicant: Insyde Software Corporation, Taipei City (TW)

(72) Inventors: Chih-Chieh SHEN, Taipei City (TW); Shih-Chieh WANG, Taipei City (TW)

(21) Appl. No.: 15/487,076

(22) Filed: Apr. 13, 2017

(30) Foreign Application Priority Data
Apr. 13, 2016 (TW) 105111471

(51) Int. Cl. H04L 12/24; G06F 11/34; G06F 11/32; H04L 29/08; G06F 11/30

(52) U.S. Cl. CPC H04L 41/069; H04L 67/36; H04L 41/22; G06F 11/3013; G06F 11/3495; G06F 11/328; H04L 41/0681

(57) ABSTRACT

An image-type notification and recording method of a hardware event and status of an electronic device, including the following steps: storing at least one mainboard image and image data to firmware; transmitting, by a component, a detected text or digit corresponding to an event or a status to a processor; reading, by the processor, the mainboard image and the image data in the firmware; and displaying, by the processor, according to the text or digit corresponding to the event or the status, the mainboard image of a warning image combined with the corresponding event or status. The present invention also provides an image-type notification and recording system of a hardware event and status of an electronic device, a recording medium, and a computer program product.

### BACKGROUND

### Technical Field

The present invention relates to the field of an electronic device, and in particular, to an image-type notification and recording method and system of a hardware event and status of an electronic device, a recording medium, and a computer program product.

### Related Art

Currently, hardware of many electronic devices records events (such as various errors, exceptions, or security notifications) generated or statuses (such as temperatures, voltages, and an enabling/closing state of a switch) detected when the hardware is run, and actively or passively notifies an administrator for appropriate follow-up processing.

However, all notifications or records of the events generated by or the statuses detected by the hardware of the electronic device are displayed in a manner of literal or numeric data. Only if the administrator can recognize meaning represented by a language, a character, and a number, the administrator can understand and perform a corresponding program. When system architecture of an electronic device is large (for example, a system formed by multiple groups of servers), it definitely causes difficulty for the administrator to recognize meaning of the literal or numeric data in a large quantity, may cost much time of the administrator in searching for the meaning, and may further cause a problem such as a recognition error.

### SUMMARY

In view of the foregoing problems, the present invention is directed to provide an image-type notification and recording method and system of a hardware event and status of an electronic device, a recording medium, and a computer program product, so as to display a component in an electronic device in a manner of an image, and record and transmit, according to meaning represented by a corresponding text or digit of the component, a hardware event and status in a manner of such as color-rendering an image of the component, and by means of a dialog box or an arrow that are enough to label the component, so that an administrator can easily and quickly learn all information and prevent a recognition error from occurring.

A first aspect of the present invention provides an image-type notification and recording method of a hardware event and status of an electronic device, including the following steps:

storing at least one mainboard image and at least one piece of image data to firmware;

transmitting, by at least one component, a detected text or digit corresponding to an event or a status to a processor;

reading, by the processor, the at least one mainboard image and the at least one piece of image data in the firmware; and

displaying, by the processor, according to the text or digit corresponding to the event or the status and the at least one piece of image data, the at least one mainboard image of a warning image combined with the corresponding event or status.

A second aspect of the present invention provides an image-type notification and recording system of a hardware event and status of an electronic device, including:

an output device;

firmware, configured to store at least one mainboard image and at least one piece of image data; and a processor, configured to: receive a text or digit corresponding to an event or a status detected by at least one component, read the at least one mainboard image and the at least one piece of image data in the firmware; and display, according to the text or digit corresponding to the event or the status and the at least one piece of image data, on the output device the at least one mainboard image of a warning image combined with the corresponding event or status.

A third aspect of the present invention is a computer readable recording medium that internally stores a program, when an image-type notification and recording system of a hardware event and status of an electronic device loads and executes the program, the computer readable recording medium can complete the method according to the first aspect of the present invention.

A fourth aspect of the present invention is a computer program product that internally stores a program, when an image-type notification and recording system of a hardware event and status of an electronic device loads and executes the program, the computer program product can complete the method according to the first aspect of the present invention.

### BRIEF DESCRIPTION OF THE DRAWINGS

FIG. 1 is a block diagram of some components of an electronic device according to the present invention;

FIG. 2 is a block diagram of a mainboard image according to a first embodiment of the present invention;

FIG. 3 is a block diagram of a mainboard image according to a second embodiment of the present invention;

FIG. 4 is a block diagram of a mainboard image according to a third embodiment of the present invention;

FIG. 5 is a block diagram of a mainboard image that has a warning image according to a first embodiment of the present invention;

FIG. 6 is a block diagram of a mainboard image that has a warning image according to a second embodiment of the present invention;

FIG. 7 is a block diagram of a mainboard image that has a warning image according to a third embodiment of the present invention;

FIG. 8 is a flowchart of an image-type notification and recording method of a hardware event and status of an electronic device according to a first embodiment of the present invention;

FIG. 9 is a flowchart of an image-type notification and recording method of a hardware event and status of an electronic device according to a second embodiment of the present invention; and

FIG. 10 is a flowchart of an image-type notification and recording method of a hardware event and status of an electronic device according to a third embodiment of the present invention.

### DETAILED DESCRIPTION

To make a person of ordinary skill in the prior art who is familiar with the present invention further understand the present invention, the following presents preferred embodiments of the present invention, and with reference to the drawings, describes in detail constituted content and efficacy to be achieved.

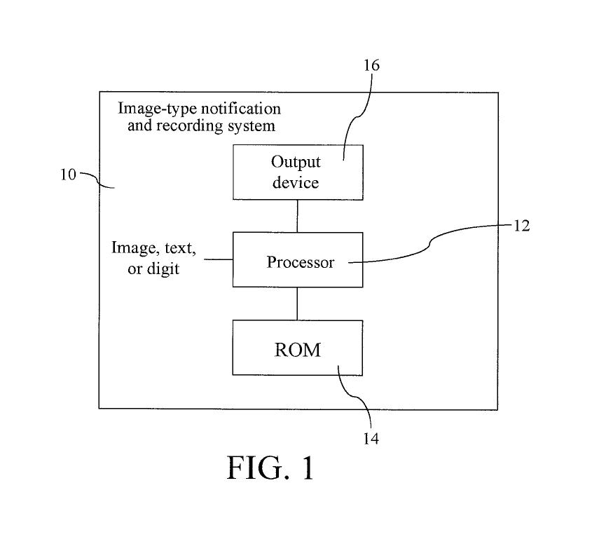

FIG. 1 is a block diagram of some components of an electronic device according to the present invention. In FIG. 1, for example, an image-type notification and recording system 10 of an electronic device of a server includes a processor 12, a ROM (read-only memory) 14 as firmware and an output device 16. The output device 16 may be an entity screen, a virtual screen, a console redirection (Console Redirection), a printer, a fax machine, or the like. The output device 16 is nearby installed on for example, a system of a server, or remotely installed on for example, a system of a monitor, a network, or a cloud in a manner of entity connection or wireless connection manner, and performs image transmission by using a transmission system (for example, in a manner of transmitting software, an email, or a short message service message).

The ROM 14 stores at least one mainboard image and at least one piece of image data. The at least one piece of image data is relative locations or dimensions of an image of a component that cannot be or can be monitored and an image of a component that can be monitored and that are on a mainboard image. The mainboard image may be an image combined with an image that cannot be monitored or an image of a component that can be monitored, or may be a blank image of a geometric figure satisfying a dimension. The component image may be an image of a symbol or an image of a geometric figure (such as a rectangle or an ellipse) satisfying a dimension that represent the component.

The mainboard image and the at least one piece of image data are stored in the ROM 14 by using an external flash programmer, a remote server, or a cloud.

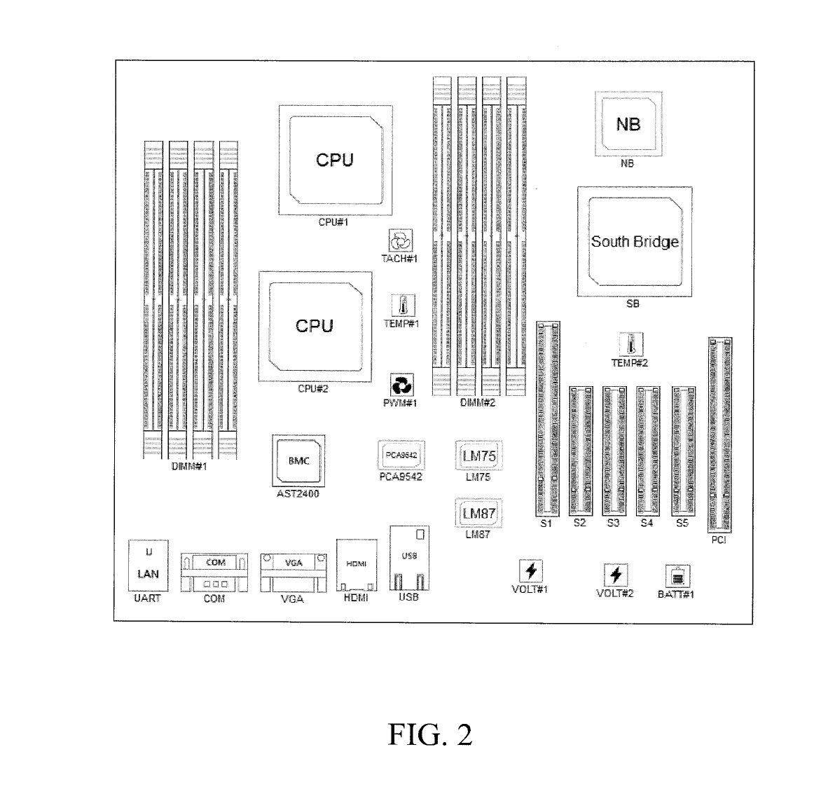

FIG. 2 is a block diagram of the mainboard image according to a first embodiment of the present invention. The mainboard image in FIG. 2 is combined with an image of a component (such as a CPU, and a SouthBridge) that cannot be monitored and a component (such as a fan switch (TACH#1, PWM#1), a temperature sensor (TEMP#1, TEMP#2), a voltage sensor (VOLT#1, VOLT#2), and a battery capacity sensor (BATT#1)) that can be monitored.

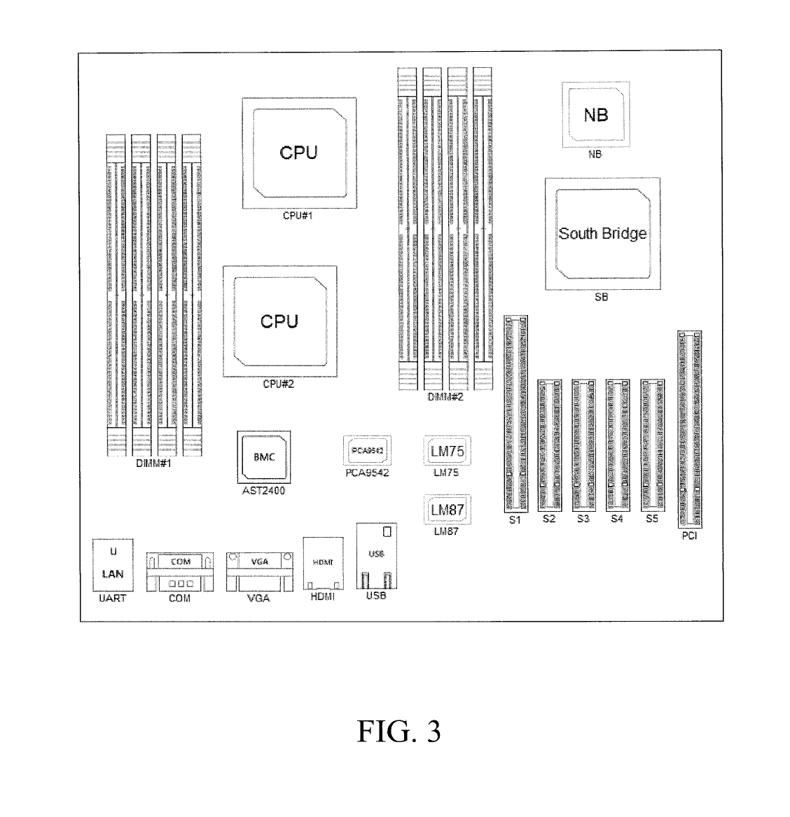

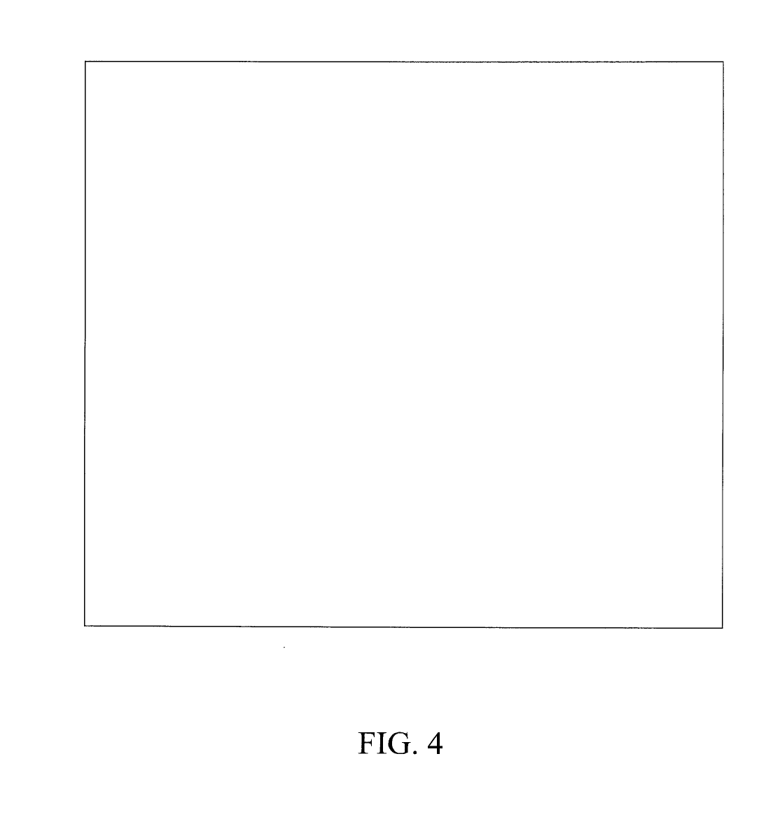

Other than a display manner in FIG. 2, a display manner of the mainboard image may further be an image in which the mainboard image is only combined with the component that cannot be monitored. As shown in FIG. 3, FIG. 3 is a block diagram of a mainboard image according to a second embodiment of the present invention, or a blank image of a mainboard image that only has a dimension. As shown in FIG. 4, FIG. 4 is a block diagram of a mainboard image according to a third embodiment of the present invention.

The processor 12 receives a text or digit corresponding to an event or a status detected by at least one component (the temperature sensor, the voltage sensor, the battery capacity sensor) of an electronic device (not shown in the figure) detected by at least one component, or the processor 12 sends a request to at least one component and requires the at least one component to perform detection, and the processor 12 receives the text or digit corresponding to the event or the status that is accordingly detected and sent by the at least one component.

The processor 12 reads the mainboard image and image data in the ROM 14. The processor 12 performs combination according to a relative location or a dimension of the component image on the mainboard image, and displays on the output device 16 the mainboard image combined with an image of the component that cannot be or can be monitored, as shown in FIG. 2 and FIG. 3.

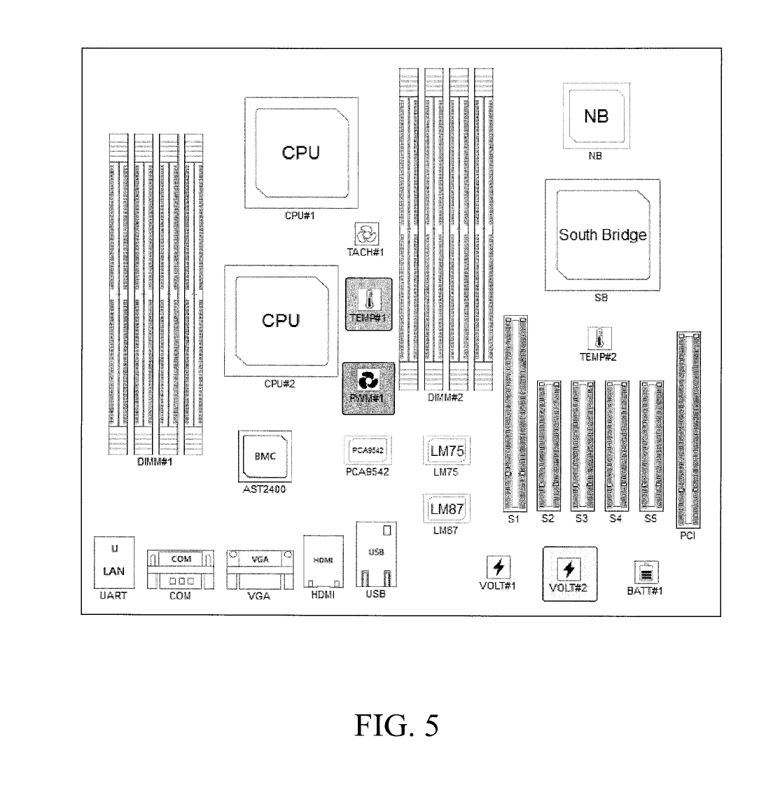

The component in the electronic device has a corresponding component image, that is, the text or digit corresponding to the event or the status detected by the component also has a corresponding component image. The processor 12 displays, according to the text or digit received by the processor 12, on the output device 16 a mainboard image of a warning image combined with a corresponding component image. The processor 12 generates the warning image according to the relative location of the image of the component that can be monitored, on the mainboard image by means of color rendering, a dialog box, an area selection, or arrow indication that labels the image of the component that can be monitored. As shown in FIG. 5, FIG. 5 is a block diagram of a mainboard image that has a warning image according to a first embodiment of the present invention. In the first embodiment, the processor 12 displays on the output device 16 the mainboard image combined with the warning image.

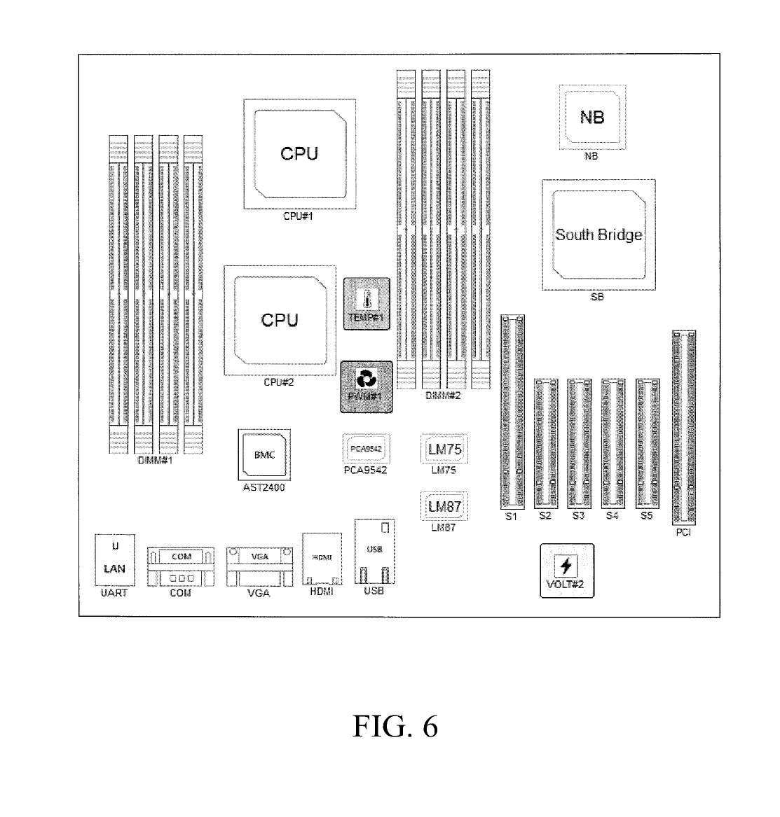

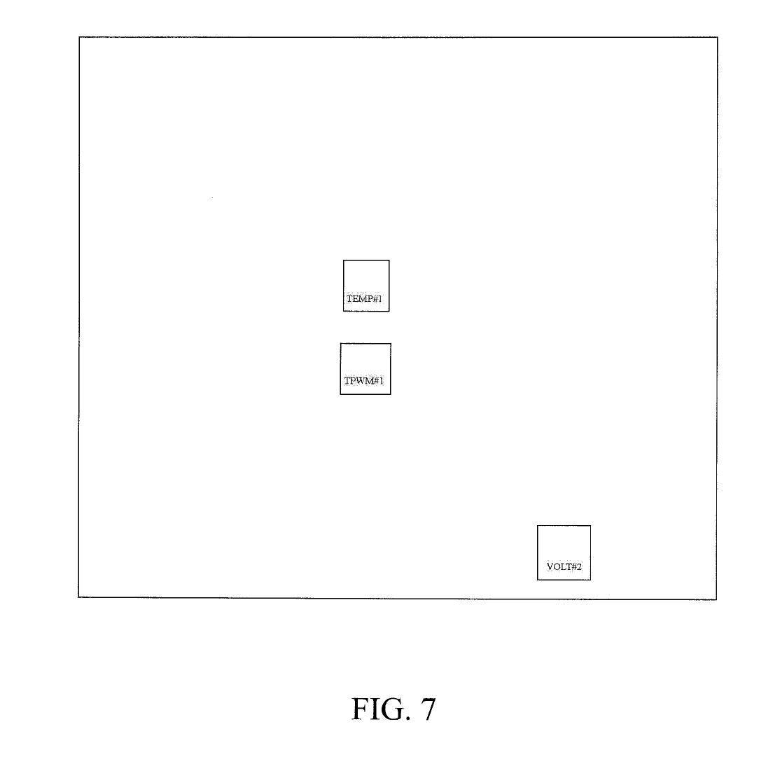

The mainboard image shown in FIG. 5 is combined with the image of the component that cannot be monitored, the image of the component that can be monitored, and the warning image. In a second embodiment, the mainboard image is combined with the image of the component that cannot be monitored and the warning image, the component image corresponding to the component in which no event or status occurs is not combined with the mainboard image and not displayed on the output device 16. As shown in FIG. 6, FIG. 6 is a block diagram of a mainboard image that has a warning image according to a second embodiment of the present invention. In a third embodiment, the mainboard image, that is a blank image, is combined with the component image corresponding to the component in which an event or a status occurs and displayed together on the output device 16. As shown in FIG. 7, FIG. 7 is a block diagram of a mainboard image that has a warning image according to a third embodiment of the present invention.

To strengthen a warning effect of the warning image in the mainboard image, a implementation method is to prepare two images at the same time. One is an original mainboard image (which may have or not have an image of a component that can be monitored), the other is a mainboard image having a warning image. Display manners of the two images are switched in turn, so as to implement a flickering effect of the image of the component in which an event or a status occurs. Each warning image is to strengthen a warning effect in manners of different colors, different darkness of a color, grayscaling, fading-in and fading-out (fade-in, fade-out), zooming-in and zooming-out, arrow indication, area selection, and a dialog box.

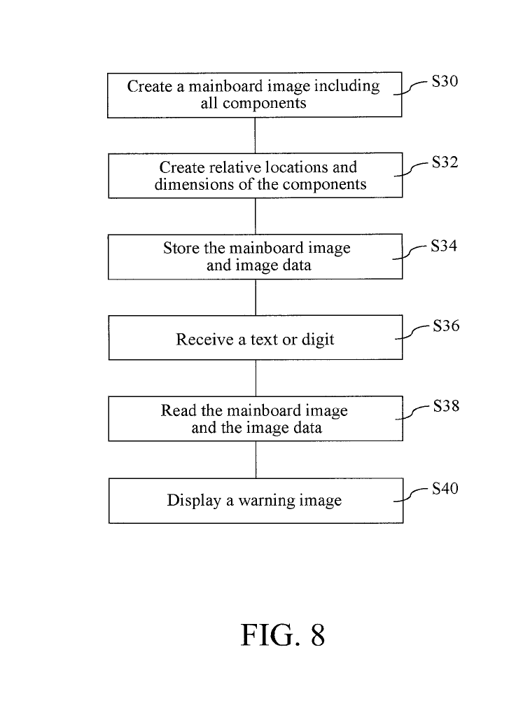

FIG. 8 is a flowchart of an image-type notification and recording method of a hardware event and status of an electronic device according to a first embodiment of the present invention. When describing a process and step in FIG. 8, refer to a component in FIG. 1 and figures of FIG. 2 and FIG. 5.

In the first embodiment, first create a mainboard image shown in FIG. 2 (step S30). The mainboard image in FIG. 2 is combined with an image of a component that cannot be monitored (such as an image of a CPU and a SouthBridge) and an image of a component that can be monitored (such as an image of a fan switch (TACH#1, PWM#1), a temperature sensor (TEMP#1, TEMP#2), a voltage sensor (VOLT#1, VOLT#2), and a battery capacity sensor (BATT#1)). Later, create a relative location and a dimension of the image of the component that can be monitored on the mainboard image and use the relative location and the dimension as image data (step S32).

Store at least one mainboard image and at least one piece of image data in the ROM 14 by using an external flash programmer, a remote server, or a cloud (step S34).

The processor 12 receives a text or digit corresponding to an event or a status detected by at least one component (the temperature sensor, the voltage sensor, the battery capacity sensor) of an electronic device (not shown in the figure) detected by at least one component, or the processor 12 sends a request to at least one component and requires the at least one component to perform detection, and the processor 12 receives the text or digit corresponding to the event or the status that is accordingly detected and sent by the at least one component (step S36).

The processor 12 reads the mainboard image (as shown in FIG. 2) in the ROM 14, combined with the image of the component that can be and cannot be monitored, and the image data of the relative location and the dimension of the component image on the mainboard image (step S38). The processor 12 performs combination according to a relative location or a dimension of the component image on the mainboard image, and displays on the output device 16 the mainboard image combined with an image of the component that can be and cannot be monitored, as shown in FIG. 2.

The component in the electronic device has a corresponding component image, that is, the text or digit corresponding to the event or the status detected by the component also has a corresponding component image. The processor 12 displays, according to the text or digit received by the processor 12, on the output device 16 a mainboard image of a warning image combined with a corresponding component image.

The processor 12 generates the warning image according to the relative location and the dimension of the image of the component that can be monitored, on the mainboard image by means of color rendering, a dialog box, an area selection, or arrow indication that labels the image of the component that can be monitored. FIG. 5 shows images of a fan switch (PWM#1) a temperature sensor (TEMP#1), a voltage sensor (VOLT#2), and the processor 12 is combined with the mainboard image of the warning image and displayed on the output device 16.

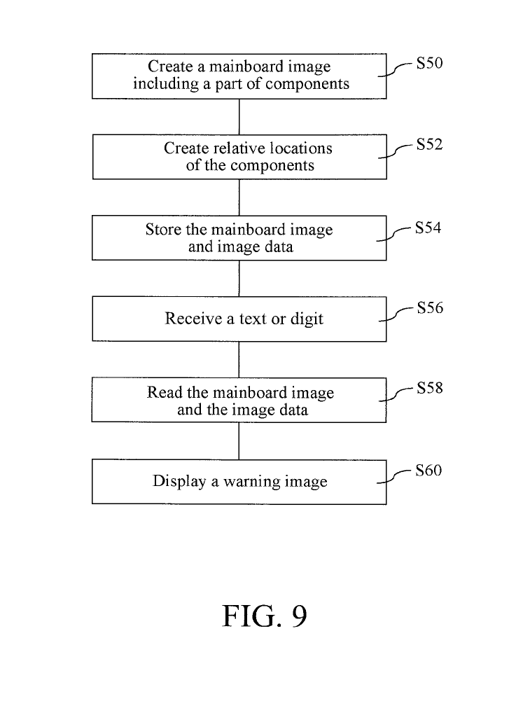

FIG. 9 is a flowchart of an image-type notification and recording method of a hardware event and status of an electronic device according to a second embodiment of the present invention. When describing a process and step in FIG. 9, refer to a component in FIG. 1 and figures of FIG. 3 and FIG. 6.

In the second embodiment, first create a mainboard image shown in FIG. 3 (step S50). The mainboard image in FIG. 3 is combined with an image of a component that cannot be monitored, and a separate image of a component that can be monitored is created additionally. Later, create a relative location of the image of the component that can be monitored, on the mainboard image and use the relative location as image data (step S52).

Store at least one mainboard image shown in FIG. 3 in the ROM 14 by using an external flash programmer, a remote server, or a cloud. Additionally make an image of the component that can be monitored and at least one piece of image data(step S54).

The processor 12 receives a text or digit corresponding to an event or a status detected by at least one component (the temperature sensor, the voltage sensor, the battery capacity sensor) of an electronic device detected by at least one component, or the processor 12 sends a request to at least one component and requires the at least one component to perform detection, and the processor 12 receives the text or digit corresponding to the event or the status that is accordingly detected and sent by the at least one component (step S56).

The processor 12 reads the mainboard image (as shown in FIG. 3) in the ROM 14, combined with the image of the component that can be and cannot be monitored. Additionally make the image of the component that can be monitored and the image data of the relative location of the component image on the mainboard image (step S58).

The component in the electronic device has a corresponding component image, that is, the text or digit corresponding to the event or the status detected by the component also has a corresponding component image. The processor 12 reads the image of the corresponding component according to the text or digit corresponding to the event or the status. Therefore, the processor 12 only read the images of some components that can be monitored, and the processor 12 performs combination according to relative locations of the images of the some components that can be monitored, on the mainboard image, and displays on the output device 16 the mainboard image combined with the images of the some component that can be and cannot be monitored, as shown in FIG. 6.

The processor 12 displays, according to the text or digit received by the processor 12, on the output device 16 a mainboard image of a warning image combined with the some corresponding component images.

The processor 12 generates the warning image according to the relative locations of images of some components that can be monitored, on the mainboard image by means of color rendering, a dialog box, an area selection, or arrow indication that labels the images of the some components that can be monitored. FIG. 6 shows images of a fan switch (PWM#1) a temperature sensor (TEMP#1), a voltage sensor (VOLT#2), and the processor 12 displays on the output device 16 the mainboard image combined with the warning image.

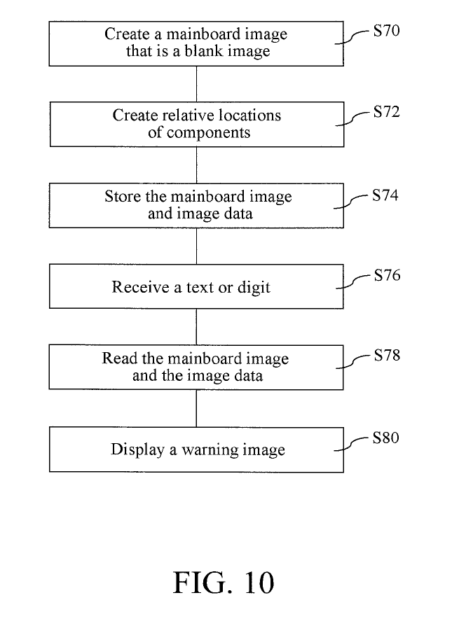

FIG. 10 is a flowchart of an image-type notification and recording method of a hardware event and status of an electronic device according to a third embodiment of the present invention. When describing a process and step in FIG. 10, refer to a component in FIG. 1 and figures of FIG. 4 and FIG. 7.

In the third embodiment, create a mainboard image that is a blank image shown in FIG. 4 (step S70). A separate image of a component that can be monitored is selectively made, and the component image may be an image of a symbol or may be an image of a geometric figure (such as a rectangle or an ellipse) satisfying a dimension that represent a component as shown in FIG. 7. Later, create a relative location of the image of the component that can be monitored on the mainboard image and use the relative location as image data (step S72).

Store at least one mainboard image shown in FIG. 4 in the ROM 14 by using an external flash programmer, a remote server, or a cloud, and selectively make an image of the component that can be monitored and at least one piece of image data (step S74).

The processor 12 receives a text or digit corresponding to an event or a status detected by at least one component (the temperature sensor, the voltage sensor, the battery capacity sensor) of an electronic device detected by at least one component, or the processor 12 sends a request to at least one component and requires the at least one component to perform detection, and the processor 12 receives the text or digit corresponding to the event or the status that is accordingly detected and sent by the at least one component (step S76).

The processor 12 reads the mainboard image (as shown in FIG. 4) which is a blank image in the ROM 14. Additionally make an image of a component that can be monitored and image data of a relative location of the component image on the mainboard image (step S78).

The component in the electronic device has a corresponding component image, that is, the text or digit corresponding to the event or the status detected by the component also has a corresponding component image. The processor 12 reads the image of the corresponding component that can be monitored, according to the text or digit corresponding to the event or the status. Therefore, the processor 12 only read images of some components that can be monitored, and the processor 12 performs combination according to relative locations of the images of the some components that can be monitored, on the mainboard image, and displays on the output device 16 the mainboard image combined with the images of the some components that can be and cannot be monitored, as shown in FIG. 7.

The processor 12 displays, according to the text or digit received by the processor 12, on the output device 16 a mainboard image of a warning image combined with the some corresponding component images.

The processor 12 generates the warning image according to the relative locations of the images of the some component that can be monitored, on the mainboard image by means of color rendering, a dialog box, an area selection, or arrow indication that labels the images of the some component that can be monitored. FIG. 7 shows images of a fan switch (PWM#1) a temperature sensor (TEMP#1), a voltage sensor (VOLT#2), and the processor 12 displays on the output device 16 the mainboard image combined with the warning image.

Writing of the image-type notification and recording method of a hardware event and status of an electronic device of the present invention may be completed in a program manner, and the program is stored in a computer readable recording medium. After the image-type notification and recording system of a hardware event and status of an electronic device loads and executes the program on the recording medium, the image-type notification and recording system can complete the methods and steps as shown in the foregoing descriptions and figures.

The image-type notification and recording method of a hardware event and status of an electronic device of the present invention may be completed by a computer program product that internally stores a program, and for example, after the image-type notification and recording system of a hardware event and status of an electronic device downloads the program from the Internet and executes the program, the image-type notification and recording system can complete the methods and steps as shown in the foregoing descriptions and figures.

The present invention provides an image-type notification and recording method and system of a hardware event and status of an electronic device, a recording medium, and a computer program product, so as to display a component in an electronic device in a manner of an image, and record and transmit, according to meaning represented by a corresponding text or digit of the component, a hardware event and status in a manner of such as color-rendering an image of the component, and by means of a dialog box or an arrow that are enough to label the component, so that an administrator can easily and quickly learn all information and prevent a recognition error from occurring.

The present invention is described above with reference to preferred embodiments and exemplary drawings, and the present invention shall not be limited thereto. Any modification, omission, and change made, about aspects and embodiment content of the present invention, by a person skilled in the prior art shall fall within the claimed scope of the claims of the present invention.

### SYMBOL DESCRIPTIONS

10 Image-type notification and recording system

12 Processor

14 ROM

16 Output device

1. An image-type notification and recording method of a hardware event and status of an electronic device, comprising the following steps:
storing at least one mainboard image and a plurality of image data to firmware, the plurality of image data is a plurality of component images which cannot be and can be monitored;
transmitting, by at least one component, a detected text or digit corresponding to an event or a status to a processor;
reading, by the processor, the at least one mainboard image and the plurality of image data in the firmware; and
displaying, by the processor, according to the text or digit corresponding to the event or the status and the plurality of image data, the at least one mainboard image of a warning image combined with the corresponding event or status.

2. The method according to claim 1, wherein the plurality of image data is a relative location or a dimension of the plurality of component images on the at least one mainboard image.

3. The method according to claim 2, wherein the component image is an image of a symbol or an image of a geometric figure representing the at least one component.

4. The method according to claim 2, wherein the warning image is generated by implementing one of: different colors, different darkness of a color, grayscaling, fading-in and fading-out, zooming-in and zooming-out, arrow indication, area selection, or a dialog box on the corresponding the plurality of component images.

5. The method according to claim 1, wherein in the step of storing the at least one mainboard image and the plurality of image data to the firmware, an external flash programmer or a remote server or a cloud stores the at least one mainboard image and the plurality of image data to the firmware.

6. The method according to claim 1, wherein in the step of transmitting, by the at least one component, the detected text or digit corresponding to the event or the status to the processor, the at least one component sends the text or digit corresponding to the event or the status to the processor when detecting the event or the status, or the processor sends a request to the at least one component and requires the at least one component to perform detection, and the at least one component sends the detected text or digit corresponding to the event or the status to the processor.

7. The method according to claim 2, wherein in the step of displaying, by the processor, according to the text or digit corresponding to the event or the status, the at least one mainboard image of the warning image combined with the corresponding event or status, the displayed at least one mainboard image is one of: a blank image, an image combined with the plurality of component images that cannot be monitored, or an image combined with the plurality of component images that can be and cannot be monitored.

8. An image-type notification and recording system of a hardware event and status of an electronic device, comprising:
an output device;
firmware, configured to store at least one mainboard image and a plurality of image data; and
a processor, configured to: receive a text or digit corresponding to an event or a status detected by at least one component, read the at least one mainboard image and the plurality of image data in the firmware, the plurality of image data is a plurality of component images which cannot be and can be monitored; and display, according to the text or digit corresponding to the event or the status and the plurality of image data, on the output device the at least one mainboard image of a warning image combined with the corresponding event or status.

9. The system according to claim 8, wherein the plurality of image data is a relative location or a dimension of the plurality of component images on the at least one mainboard image.

10. The system according to claim 9, wherein the plurality of component images is an image of a symbol or an image of a geometric figure representing the at least one component.

11. The system according to claim 9, wherein the warning image is generated by implementing one of: different colors, different darkness of a color, grayscaling, fading-in and fading-out, zooming-in and zooming-out, arrow indication, area selection, or a dialog box on the corresponding plurality of component images.

12. The system according to claim 8, wherein the processor receives the text or digit corresponding to the event or the status sent by the at least one component when the at least one component detects the event or the status, or the processor sends a request to the at least one component and requires the at least one component to perform detection, and receives the text or digit corresponding to the event or the status that is accordingly detected and sent by the at least one component.

13. The system according to claim 9, wherein the at least one mainboard image is one of: a blank image, an image combined with the plurality of component images that cannot be monitored, or an image combined with the plurality of component images that can be and cannot be monitored.

14. The system according to claim 8, wherein the output device is one of: an entity screen, a virtual screen, a console redirection, a printer, or a fax machine.

15. A computer readable recording medium that internally stores a program, when an image-type notification and recording system of a hardware event and status of an electronic device loads and executes the program, the computer readable recording medium can complete the method according to claim 1.
